(19) United States
(12) Patent Application Publication
(10) Pub. No.: US 2013/0191637 A1
(43) Pub. Date: Jul. 25, 2013

(54) METHOD AND APPARATUS FOR AUTHENTICATED ENCRYPTION OF AUDIO

(71) Applicants: Marc Smaak, Bergen op Zoom (NL); Stephan van Tienen, Bergen op Zoom (NL); James Newsome, Pittsburgh, PA (US); Torsten Schuetze, Moeglingen (DE)

(72) Inventors: Marc Smaak, Bergen op Zoom (NL); Stephan van Tienen, Bergen op Zoom (NL); James Newsome, Pittsburgh, PA (US); Torsten Schuetze, Moeglingen (DE)

(73) Assignee: ROBERT BOSCH GMBH, Stuttgart (DE)

(21) Appl. No.: 13/638,647

(22) PCT Filed: Mar. 31, 2010
(86) PCT No.: PCT/EP2010/054317

§ 371 Date: Apr. 16, 2013

(51) Int. Cl. H04L 9/32

(52) U.S. Cl. CPC H04L 9/32
USPC 713/168

(57) ABSTRACT

The invention provides for a method of encoding data and a method for decoding encrypted and authenticity protected data. Furthermore, the invention provides for an encoding and a decoding equipment. For encoding the data is encrypted by using AES encryption (16, 52) and authenticity protected by calculating a CMAC algorithm (26) over the data.

### TECHNICAL FIELD

The invention provides for a method of encoding data, especially audio data and a method of decoding encrypted and authenticity (integrity) protected data. Furthermore, the invention provides for an encoding equipment and a decoding equipment. Encryption is commonly used to prevent eavesdropping and tampering with data.

### BACKGROUND ART

In a digital audio system one part of data contains audio content. Since digital audio is generated on a regular time interval which is called the audio sample frequency it is common to collect a larger block of data and protect this data block via encryption. This is even the case in systems that use some kind of live audio, e.g. a telephone system, although the amount of data is limited to avoid too much audio latency.

After encryption the data is processed for the second time to add authenticity (integrity) protection. This is essential for avoiding unauthorized manipulation of data. Recent results have shown that encrypted data also requires message authentication when facing active attackers. Next to this, authenticity (integrity) protection also protects against attacks at the data when the content of the encrypted data is known. For audio data this can happen in the event of transporting standard audio samples, e.g. attention tones, at the beginning of audio transmission. After encryption the data is processed for a second time to add authenticity (integrity) protection. This is essential for avoiding unauthorized manipulation of the encrypted data. In particular, without this protection an attacker who knew or could guess the unencrypted value of a particular encrypted data packet could easily and undetectably replace it with his own chosen audio.

For instance, the Secure Real-time Protocol (SRTP) uses this techniques. SRTP defines a profile of Real-time Transport Protocol (RTP) intended to provide encryption, message authentication and integrity as well as replay protection to the RTP data in both unicast and multicast applications. The main disadvantage of SRTP when used for audio transmission is the use of larger data. This will add latency to the signal.

In cryptography, CMAC (Cipher-based MAC) is known as a cipher-based message authentication code algorithm. A description of CMAC can be found in publication of M. Bellare and N. Namprempre; Authenticated Encryption: Relations among notions and analysis of the generic composition paradigm.

It is to be noted that in live music systems ultra low latency is required to avoid losing the rhythm for the musician. Since any processing, e.g. analog digital conversion, audio processing, transmission of data, will add latency to the audio data, it is important that encryption and decryption latency are as low as possible, e.g. <0.05 ms. This means that processing should take place on a sample by sample basis.

### DISCLOSURE OF THE INVENTION

The invention provides for a method of encoding data according to claim 1 and a method for decoding encrypted and authenticity (integrity) protected data according to claim 6. Moreover, the invention provides for an encoding equipment according to claim 9 and a decoding equipment according to claim 10. Subject matter of the dependent claims define embodiments of the invention.

At least in one of the embodiments, the invention realizes audio encryption based upon AES and authenticity (integrity) protection without adding any relevant additional latency to the digital audio stream, e.g. <1 μs for practical implementations, and without the need for additional synchronisation data. The used encryption technology is known and well accepted as secure in the field. Therefore, the method can be performed for ultra low latency audio encryptions to detect wrong key setting based upon CMAC failure and mute audio to avoid distorted audio data.

The smart combination of technologies and the way these technologies are used for a live digital audio system allows for ultra low latency in data encryption and authenticity protection.

The methods proposed can use standard AES (Advanced Encryption Standard) encryption in Cipher feedback mode (AES-CFB). Using this method removes the need for additional synchronisation. It is possible to encrypt the data on a per sample basis, i.e. on a sample by sample basis, and decrypt it again without any additional synchronisation data. Furthermore, it is possible to decrypt without knowing the initialisation vector from the encryption. However, it takes the number of bits from the cipher-block before the correct data can be decrypted.

After encryption authenticity protection is added by calculating a CMAC over the data. CMAC (Cipher-based MAC) is a block cipher-based message authentication code algorithm that can be used to provide assurance of the authentication and the integrity of binary data. Preferably, the encryption and CMAC part use different keys.

The number of bits used for the CMAC are a trade-off between the required security level and the additional data that has to be transported, stored and processed.

Combining the CMAC with the AES-CFB has next to authenticity protection the advantage that it is possible to detect whether the CMAC authenticity check is successful from a single audio sample. If this is the case, it takes the number of bits in the Cipher-block before the AES-CFB decryption is successful.

This information can be used to mute the audio until this moment to avoid playback of corrupted data. In this way, it is possible to connect an additional audio receiver to a running encrypted audio stream in case the receiver has the proper keys. There is no need for synchronizing the initialisation vector at the moment the receiver has to start.

As authenticity protection of the raw data does not help against replay it might be suitable to add time variant data, e.g. random data, nonce, time stamp, to the audio to achieve replay protection.

### BRIEF DESCRIPTION OF THE DRAWINGS

FIG. 1 shows a method of encoding audio data for encrypted and authenticity (integrity) protected audio data.

FIG. 2 shows a method of decoding encrypted and authenticity (integrity) protected audio data.

### DESCRIPTION OF EMBODIMENTS

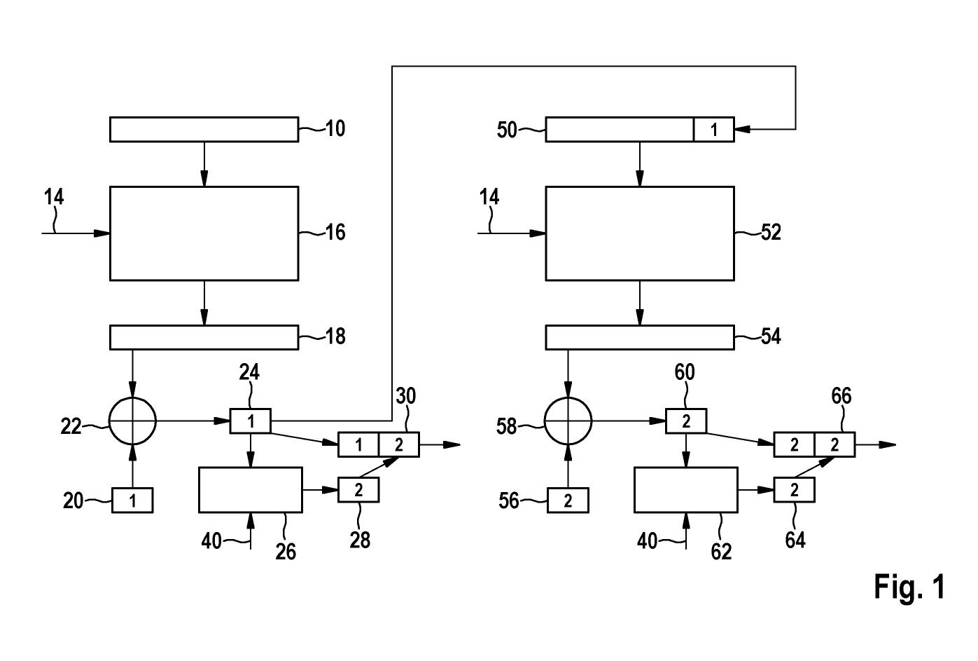

FIG. 1 shows encoding an audio sample according to the method described. The left side of the drawing shows operations during audio sample period n, the right side shows operations during audio sample period n+1. This illustrates that the method is performed on a sample by sample basis.

### Audio Sample Period n

Reference number 10 is the current 128-bit Initialization Vector (IV) initialized to a randomly chosen value when processing the first audio sample n=0. Initialization Vector 10 is encrypted with a 128 bits key (1) 14 in an AES encryption process 16 to produce a keystream (1) 18.

Furthermore, a 24-bits audio sample 20 (sample period n) is combined with the keystream (1) 18 by a logical operation 22, in this case XOR, to produce a 24-bits encrypted audio sample 24. This audio sample 24 is put into an AES-CMAC algorithm 26 together with a 128-bits key (2) 40 to form a 24-bits CMAC 28. The encrypted audio sample 24 and the CMAC 28 are combined to define a secure audio sample 30 for audio sample period n.

Audio Sample Period n+1

The current Initialization Vector for audio sample n+1, reference number 50, is the 24-bits encrypted audio sample 24, concatenated with 104-bits from the previous Initialization Vector 10. The Initialization Vector (IV) 50 is then encrypted with the 128-bits key (1) 14 in an AES encryption process 52 to produce a keystream (2) 54. This keystream (2) 54 is combined with a 24-bits audio sample (sample period n+1) 56 by a logical operation 58, in this case XOR, to produce a 24-bits encrypted audio sample 60. This audio sample 60 is put into an AES-CMAC algorithm 62 together with the 128-bits key (2) 40 to form a 24-bits CMAC 64. The encrypted audio sample 60 and the CMAC 64 are combined to form a secure audio sample 66 for audio sample period n+1.

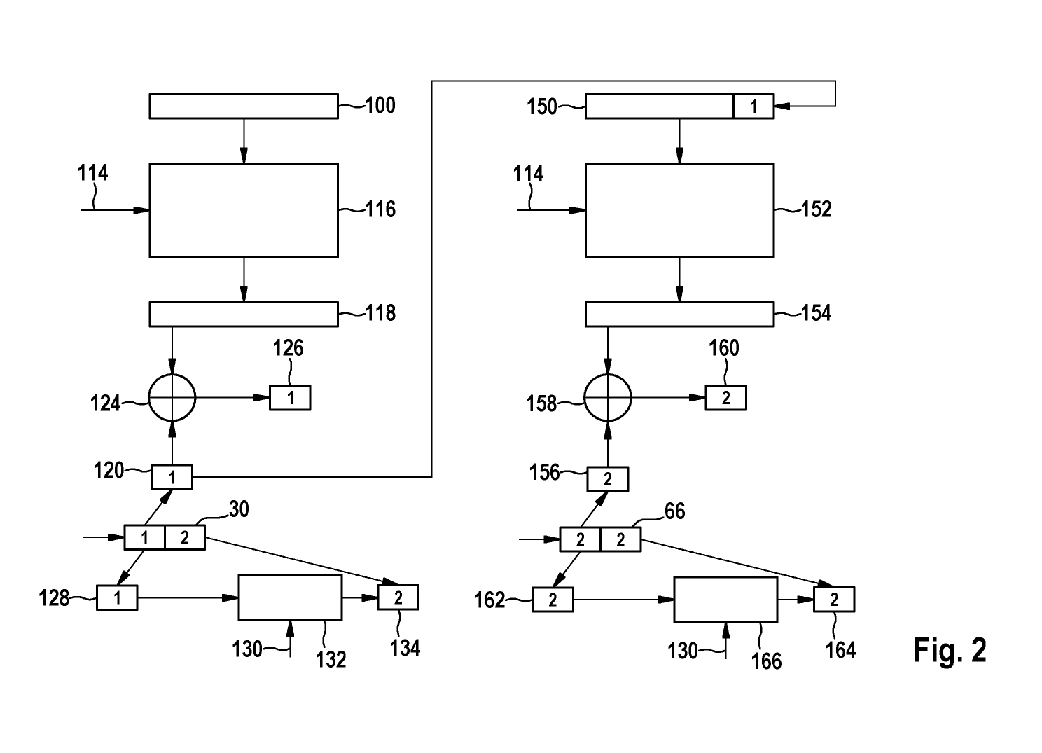

FIG. 2 shows decoding encrypted and authenticity (integrity) protected audio data. The left side of the drawing shows operations during audio sample period n, the right side shows operations during audio sample period n+1.

### Audio Sample Period n

The 128-bit Initialization Vector (IV) 100 has the same value as item 10 of FIG. 1. The Initialization Vector 100 is encrypted with a 128 bits key (1) 114 in an AES encryption process 116 to produce a keystream (1) 118.

Secure audio sample 30 of FIG. 1 comprising a ciphertext 120 and a 24-bits CMAC 30. The ciphertext 120 is combined with the keystream (1) 118 by a logical operation 124, in this case XOR, to form a plain 24-bits audio sample 126.

Furthermore, ciphertext 128 is combined with a 128-bits key (2) 130 in a AES-CMAC algorithm 132 to form a 24-bits CMAC 134 which is compared with CMAC of the secure audio sample 30.

Audio Sample Period n+1

The current Initialization Vector for audio sample, reference number 150, is the 24-bits encrypted audio sample 120, concatenated with 104-bits from the previous Initialization Vector 100. The Initialization Vector 150 is then encrypted with the 128-bits key (1) 114 in an AES encryption process 152 to produce a keystream (2) 154.

Secure audio sample 66 of FIG. 1 comprises a ciphertext 156 and a 24-bits CMAC 164. The ciphertext 156 is combined with the keystream (1) 118 by a logical operation 158, in this case XOR, to form a plain 24-bits audio sample 160.

Furthermore, the ciphertext 162 is combined with the 128-bits key (2) 130 by help of a AES-CMAC algorithm 166 to form a 24-bits CMAC 164 which is compared with CMAC of the secure audio sample 66.

The figures assume 24-bit audio sample and a 24-bit CMAC. Therefore, the amount of data is doubled. However, it is possible to reduce the number of bits used by the CMAC to have less overhead.

The methods described can be used by a secure audio system with latencies less than 1 μs.

1. A method of encoding data with ultra low latency, wherein the data is encrypted and decrypted using AES encryption and authenticity protected by calculating a CMAC over the data.

2. The method according to claim 1, wherein the decrypted audio can be muted when the authenticity check fails based upon CMAC failure.

3. The method according to claim 1, wherein the method is performed on a per sample basis.

4. The method according to claim 1, wherein the method is performed on audio data.

5. The method according to claim 1, wherein the encryption and the CMAC algorithm use different keys.

6. A method of decoding encrypted and authenticity protected data, wherein a AES encryption and a CMAC algorithm is used.

7. The method of decoding according to claim 6, wherein the method is performed on a per sample basis.

8. The method of decoding according to claim 7, wherein the method is performed on audio data.

9. Encoding equipment for encoding data comprising a first unit for AES encryption and a second unit for using a CMAC algorithm over the data.

10. Decoding equipment for decoding encrypted and authenticity protected data comprising a third unit for AES encryption and a fourth unit for using a CMAC algorithm over the data.
